(19) United States
(12) Patent Application Publication
(10) Pub. No.: US 2022/0062815 A1
(43) Pub. Date: Mar. 3, 2022

(54) SYSTEM AND METHOD FOR RECOVERING CARBON MONOXIDE CONTAINED IN INDUSTRIAL BY-PRODUCT GAS

(71) Applicant: Korea Research Institute of Chemical Technology, Daejeon (KR)

(72) Inventors: Jeong Hoon Kim, Daejeon (KR); Jong Yeol Jeon, Daejeon (KR); Bo Ryoung Park, Daejeon (KR); Ho Cheol Kang, Daejeon (KR)

(73) Assignee: Korea Research Institute of Chemical Technology, Daejeon (KR)

(21) Appl. No.: 17/460,741

(22) Filed: Aug. 30, 2021

(30) Foreign Application Priority Data
Aug. 31, 2020 (KR) 10-2020-0109928

(51) Int. Cl. B01D 53/22; B01D 71/80; B01D 71/52; B01D 71/56; B01D 71/08; B01D 71/02; C01B 32/40; C01B 32/50

(52) U.S. Cl. CPC B01D 53/226; B01D 53/228; B01D 71/80; B01D 71/52; C01B 32/50; B01D 71/08; B01D 71/022; C01B 32/40; B01D 71/56

(57) ABSTRACT

Disclosed herein is a system for recovering carbon monoxide from an industrial by-product gas, the system including a supply unit for supplying an industrial by-product gas containing carbon dioxide, nitrogen, carbon monoxide, and hydrogen, a first membrane separation unit including a separation membrane capable of allowing carbon dioxide and hydrogen to permeate, and receiving the industrial by-product gas supplied from the supply unit to allow carbon dioxide and hydrogen to permeate, and a second membrane separation unit including a polymer membrane in which a transition metal is supported, and receiving a gas remaining in the first membrane separation unit to allow carbon monoxide to permeate.

### CROSS-REFERENCE TO RELATED APPLICATIONS

This patent application claims priority to Korean Patent Application No. 10-2020-0109928, filed on Aug. 31, 2020, the contents of which are incorporated herein by reference.

### BACKGROUND OF THE INVENTION

### 1. Field of the Invention

The present invention relates to a system and a method for recovering carbon monoxide contained in an industrial by-product gas, and to a system and a method for recovering carbon monoxide to a high purity from an industrial by-product gas using only a separation membrane.

### 2. Description of the Related Art

A steel mill converter gas typically contains 64 vol % (hereinafter referred to as %) of CO (and 18% of CO₂, 16% of N₂, and 2% of H₂), and a blast furnace gas also contains about 25% of CO (21% of CO₂, 50% of N₂, and 4% of H₂). Although CO is a highly toxic gas, it is a material essentially used as a chemical raw material in the industry. Representative chemical products produced therefrom are acetic acid, diisocyanate, which is a polyurethane monomer, oxoalcohol, polyketone, and the like. In general, CO is produced by partially oxidizing a hydrocarbon such as CH₄ with oxygen, or reforming with steam. At this time, CO₂, which is a complete oxide material, is generated together with H₂, so that a purification process is required to obtain high-purity CO. As a method for separating the mixed gas, an absorption method [US Tenaco Chemical Cosorb process: Chemical Engineering J vol 59, Issue 3, November 1995 page 243-252, Costello Co's Copure process: https://www.rccostello.com/copure.html], a pressure circulation adsorption method [Japanese Unexamined Patent Application Publication No. 11-021118, Korean Patent Publication No. 10-1990-0001537] and the like are being used in commercial processes.

When CO is recovered from a steel by-product gas, there is no need to use expensive raw materials, so that raw material costs are low, and the amount of fossil fuels mined for CO production is reduced, so that there is an effect of reducing greenhouse gas emissions. However, the steel by-product gas contains not only H₂ and CO₂ but also N₂, which has no difference from CO in molecular weight and density and has a similar boiling point to CO. Therefore, due to increasing energy costs, it is difficult to economically separate CO by a typical absorption method, pressure circulation adsorption method, or liquefaction method. Among the prior arts, a membrane separation method is known as a separation method which requires low energy costs. However, a membrane separation technique for purifying CO containing dinitrogen, hydrogen, and carbon dioxide contained in a by-product gas as a chemical raw material-grade gas having a high purity of 99% or greater is yet to be developed. Particularly, it is difficult to separate between CO and N₂ which have similar physical properties, so that it is difficult to recover CO to a high purity with a typical separation membrane even when two types of separation membranes are used. Therefore, a membrane separation-pressure circulation adsorption hybrid process has been disclosed [Korean Patent Publication No. 10-2059068] in which CO₂ and H₂ are first removed using a selective separation membrane to CO₂ and H₂, and a mixed gas containing remaining CO₂ and H₂ as the main component thereof is separated by a pressure circulation adsorption method to obtain high-purity CO. Although this hybrid process is an advanced technology in terms of economic feasibility taking advantages of the two technologies, there is a problem of contamination by an adsorbent of other gases such as CO₂, and the use of an CO adsorbent, which has excellent selectivity and adsorption capacity without being deteriorated for a long time compared to the membrane separation-adsorption hybrid process, is limited. Also, when the proposed polysulfone or polyimide membrane is applied, the permeability of CO₂ is relatively very low, and the selectivity for CO₂/CO and CO/N₂ is low, so that the process is evaluated as a process with higher CO and CO₂ recovery costs than the proposed single separation membrane process.

Therefore, there has been a demand for a technique capable of more efficiently purifying and recovering CO and CO₂ to a high purity.

### PRIOR ART DOCUMENT

### Patent Document

Japanese Unexamined Patent Application Publication No. 11-021118

Korean Patent Publication No. 10-1990-0001537

Korean Patent Publication No. 10-2059068

### Non-Patent Document

Chemical Engineering J vol 59, Issue 3, November 1995 page 243-252

### SUMMARY OF THE INVENTION

One object of the present invention is to provide a system and a method for separating and recovering carbon monoxide (CO), which is contained in a by-product gas, to a high purity using only a separation membrane.

In order to achieve the object, the present invention provides a system for recovering carbon monoxide from an industrial by-product gas, the system including a supply unit for supplying an industrial by-product gas containing carbon dioxide, nitrogen, carbon monoxide, and hydrogen, a first membrane separation unit including a separation membrane capable of allowing carbon dioxide and hydrogen to permeate, and receiving the industrial by-product gas supplied from the supply unit to allow carbon dioxide and hydrogen to permeate, and a second membrane separation unit including a polymer membrane in which a transition metal is supported, and receiving a gas remaining in the first membrane separation unit to allow carbon monoxide to permeate.

The present invention also provides a method for recovering carbon monoxide from an industrial by-product gas, the method including allowing an industrial by-product gas containing carbon dioxide, nitrogen, carbon monoxide, and hydrogen to come into contact with a first membrane separation unit including a separation membrane capable of allowing carbon dioxide and hydrogen to permeate, thereby allowing the carbon dioxide and the hydrogen to permeate, and allowing a gas remaining in the first membrane separation unit to come into contact with a second membrane separation unit including a polymer membrane in which a transition metal is supported, thereby allowing carbon monoxide to permeate.

Furthermore, the present invention provides a system for processing an industrial by-product gas, the system including a supply unit for supplying an industrial by-product gas containing carbon dioxide, nitrogen, carbon monoxide, and hydrogen, a first membrane separation unit including a separation membrane capable of allowing carbon dioxide and hydrogen to permeate, and receiving the industrial by-product gas supplied from the supply unit to allow carbon dioxide and hydrogen to permeate, and a second membrane separation unit including a polymer membrane in which a transition metal is supported, and receiving a gas remaining in the first membrane separation unit to allow carbon monoxide to permeate.

The present invention also provides a method for processing an industrial by-product gas, the method including allowing an industrial by-product gas containing carbon dioxide, nitrogen, carbon monoxide, and hydrogen to come into contact with a first membrane separation unit including a separation membrane capable of allowing carbon dioxide and hydrogen to permeate, thereby allowing the carbon dioxide and the hydrogen to permeate, and allowing a gas remaining in the first membrane separation unit to come into contact with a second membrane separation unit including a polymer membrane in which a transition metal is supported, thereby allowing carbon monoxide to permeate.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically showing a first membrane separation unit according to an embodiment of the present invention;

FIG. 2 is a view schematically showing a second membrane separation unit according to an embodiment of the present invention; and

FIG. 3 a view schematically showing a carbon monoxide recovery system according to an embodiment of the present invention.

### DESCRIPTION OF THE PREFERRED EMBODIMENTS

Various changes may be made to the present invention, and accordingly, various embodiments are possible. Therefore, specific embodiments will be presented below and described in detail.

In addition, all terms herein that are not specifically defined may be used in meanings that are understandable to all those of ordinary skill in the technical field to which the present invention belongs.

However, it should be understood that it is not intended to limit the present invention only to the specific embodiments to be disclosed below, but rather, is intended to cover all modifications, equivalents, and alternatives falling within the spirit and technical scope of the present invention.

Therefore, there may be other equivalents and modifications different from the embodiments described herein, and the embodiments presented herein are only the most preferred embodiments.

In an aspect of the present invention, there is provided a system for recovering carbon monoxide from an industrial by-product gas, the system including a supply unit for supplying an industrial by-product gas containing carbon dioxide, nitrogen, carbon monoxide, and hydrogen, a first membrane separation unit including a separation membrane capable of allowing carbon dioxide and hydrogen to permeate, and receiving the industrial by-product gas supplied from the supply unit to allow carbon dioxide and hydrogen to permeate, and a second membrane separation unit including a polymer membrane in which a transition metal is supported, and receiving a gas remaining in the first membrane separation unit to allow carbon monoxide to permeate.

Hereinafter, each component of the carbon monoxide recovery system provided in an aspect of the present invention will be described in detail.

First, the carbon monoxide recovery system provided in an aspect of the present invention includes a supply unit.

The supply unit supplies an industrial by-product gas.

The supply unit may supply the industrial by-product gas to a first membrane separation unit to be described later.

The industrial by-product gas contains carbon dioxide, nitrogen, carbon monoxide, and hydrogen.

The industrial by-product gas may be a converter gas, a blast furnace gas (BFG), or a COREX furnace gas (CFG) generated in a steel making process of the steel industry.

The converter gas refers to a gas generated during a process of making steel by putting pig iron into a converter and blowing oxygen thereto. Blast furnace gas refers to a gas generated during a stage of making pig iron by putting iron ore and cokes into a blast furnace. Currently, most steel by-product gases including the converter gas and the blast furnace gas are emitted into the atmosphere after being combusted as power generation fuels. However, the carbon monoxide recovery system provided in an aspect of the present invention may recover carbon monoxide from such an industrial by-product gas.

Since the converter gas and the blast furnace gas are gases respectively derived from pig iron and cokes, toxic impurities such as SOₓ are already mostly removed during a step of manufacturing cokes through coal carbonization, and thus, the amount thereof is small. Therefore, it is possible to easily remove the impurities by a typical method.

Although the converter gas and the blast furnace gas contain a trace amount of fine particles, a gas separation membrane which may be used in the first membrane separation unit to be described later does not have a particular problem with the fine particles. A typical polymer gas separation membrane uses a method in which a gas is permeated and separated between molecules inside a thin coating membrane made of a polymer material with no pores, wherein only gas molecules permeate. Therefore, a clogging phenomenon inside the coating membrane due to fine particles does not occur. However, when the fine particles accumulate on the surface of a polymer coating membrane, pressure may increase. However, in this case, when a suitable gas is flown in a direction opposite to the coating membrane, the accumulated fine particles may be easily removed to the outside of the separation membrane.

The supply unit may further include a compressor for compressing the industrial by-product gas.

A membrane separation process in the first membrane separation unit to be described later is a process of separating a gas using the difference in partial pressure between a residual side and a permeative side, and thus, the compression of a gas to be separated is required. Therefore, the gas may be compressed through the compressor.

The pressure of the industrial by-product gas supplied from the supply unit may preferably be an absolute pressure of 5 atm to 20 atm. The higher the pressure, the higher the separation efficiency, so that the better it is when the pressure of a gas to be separated is higher. However, when the pressure of the gas exceeds 20 atm, energy costs are higher compared to other separation techniques such as an absorption method and a pressure circulation adsorption method, which may cause the problem of losing competitiveness. On the contrary, when the pressure of a gas to be separated is less than 5 atm, it is difficult to recover carbon monoxide with a high purity of 99% or greater, and the required area of a separation membrane becomes very large, which may cause the problem of increasing capital expense for securing the separation membrane.

Next, the carbon monoxide recovery system provided in an aspect of the present invention includes a first membrane separation unit.

The first membrane separation unit may include a separation membrane capable of allowing carbon dioxide and hydrogen to permeate.

The first membrane separation unit may receive an industrial by-product gas from the supply unit and allow carbon dioxide and hydrogen to permeate, and may allow carbon monoxide and nitrogen to remain.

The first membrane separation unit may be a gas separation membrane made of a polymer material capable of allowing the carbon dioxide and the hydrogen to permeate.

The separation membrane capable of allowing carbon dioxide and hydrogen to permeate may be a separation membrane having a CO₂/CO selectivity and a H₂/CO selectivity of 10 to 200, each.

In general, energy required for a separation membrane process decreases as the selectivity of a gas increases. Therefore, it is preferable to use a separation membrane having a CO₂/CO selectivity and a H₂/CO selectivity of 10 or greater.

In addition, when a CO₂/CO selectivity and a H₂/CO selectivity are excessively high and reach 100 or greater, the purity of carbon monoxide gradually decreases. At this time, if the membrane area is increased to increase the purity of carbon monoxide, the recovery rate of carbon monoxide increases, whereas required power begins to become rather greater due to an increased flow rate of a recirculated gas. Eventually, when the selectivities exceed 200, even if the membrane area is greatly increased, it is not possible to achieve a CO purity of 90 to 99%, while allowing the required power to become greater.

Therefore, when the selectivity of CO₂ and the selectivity of H₂ are excessively high, the concentrations of CO₂ and H₂ on the permeative side approach 100% in the entire section in a length direction of the separation membrane, so that partial pressure greatly increases. As a result, permeation driving power decreases, thereby decreasing the separation efficiency of CO₂ and H₂, and thus, the purity of CO on the residual side decreases. Therefore, it is preferable that the CO₂/CO and H₂/CO selectivities are 200 or less.

When the CO₂/CO and H₂/CO selectivities of the separation membrane capable of allowing carbon dioxide and hydrogen are in the range of 10 to 200, the permeability of CO₂ and H₂ may not cause a big problem.

Since a smaller membrane area is required, the higher the permeability, the better it is. However, in the case of the first separation membrane, when the permeability of CO₂ and the permeability of H₂ are each 20 GPU (1 GPU=1×10⁻⁶ cm³/cm²·s·cmHg) or higher, it is possible to recover carbon monoxide with lower capital expense and operating expense compared to other separation processes such as pressure circulation adsorption.

As a separation membrane having a permeability of carbon dioxide and a permeability of hydrogen of 20 GPU or higher while having a selectivity of 10 to 200 for CO, a polyolefin oxide-based polymer membrane may preferably be used.

More specifically, the polymer membrane may include a polyamide-block-polyethylene oxide (polyamide-b-polyethylene oxide) copolymer made of an ethylene oxide-based, propylene oxide-based, or butylene oxide-based oligomer with a polyamide such as nylon 6 and nylon 66, a polybutylene terephthalate-block-polyethylene oxide (polybutylene terephthalate) polymer, or the like.

Alternatively, the polymer membrane may include one or more polymers selected from polymers in a crosslinked form in which acrylic ester-type monomers including ethylene oxide, propylene oxide, butylene oxide oligomers and the like are polymerized by including a UV photo-crosslinking agent, and then subjected to a UV crosslinking reaction.

Alternatively, the separation membrane may include a polymer composite prepared by mixing two or more of the polymers.

The polymer in a crosslinked form in which acrylic ester-type monomers are polymerized by including a UV photo-crosslinking agent, and then subjected to a UV crosslinking reaction may be a copolymer selection layer surface-fixed and crosslinked on the surface of a polymer support layer, and the copolymer may be formed from a monomer containing an ultraviolet-reactive functional group and a polyethylene glycol-based monomer.

The separation membrane including the polymer in a crosslinked form through a UV crosslinking reaction may improve stability and weather resistance through a covalent bond between the polymer support layer and the selection layer compared to a typical polymer gas separation membrane.

The ultraviolet-reactive functional group may be a benzophenone group, an acetophenone group, a cyclohexyl phenyl ketone group, 2-hydroxy-2-methylpropiophenone group, and the like, and the monomer containing an ultraviolet-reactive functional group may include at least one of a benzophenone group, an acetophenone group, a cyclohexyl phenyl ketone group, and a 2-hydroxy-2-methylpropiophenone group.

As a specific example, the monomer containing an ultraviolet-reactive functional group may include at least one phenyl group and at least one carbonyl group (C═O), and the monomer containing an ultraviolet-reactive functional group may be 4-benzoylphenyl methacrylate, 4-acetylphenyl acrylate, 1-(1-phenylvinyl) cyclohexyl acrylate, 2-(buta-1,3-dien-2-yloxy)-2-methyl-1-phenylpropan-1-one, and the like.

In addition, the copolymer may be formed by copolymerizing a polyethylene glycol-based monomer, which is a monomer having selectivity for gas separation, and the polyethylene glycol-based monomer may be polyethylene glycol methyl ether methacrylate, polyethylene glycol acrylate, polyethylene glycol methyl ether acrylate, polypropylene glycol methyl methacrylate, polypropylene glycol methyl ether acrylate, and the like.

Furthermore, in the copolymer, the content of the monomer containing an ultraviolet-reactive functional group may be 0.1 wt % to 40 wt %, 0.5 wt % to 35 wt %, 1 wt % to 35 wt %, or 3 wt % to 30 wt %. If the content of the monomer containing an ultraviolet-reactive functional group is less than 0.1 wt %, there may be a problem in which surface fixation and crosslinking are not sufficiently achieved during UV irradiation after coating, and if the content exceeds 40 wt %, there may be a problem in which crosslinking density is too high to significantly decrease gas permeability.

In addition, it is preferable that the number average molecular weight of the copolymer is 5,000 g/mol to 5,000,000 g/mol. When the number average molecular weight of a polymer containing a UV-reactive functional group is less than 5,000 g/mol, crosslinking is not sufficiently achieved even after a photoreaction, so that a branch-type polymer may be made, and when the number average molecular weight of the polymer is greater than 5,000,000 g/mol, the viscosity during the coating is too high, so that it may be difficult to manufacture the selection layer.

Furthermore, the copolymer selection layer surface-fixed and crosslinked may include at least one phenyl group and at least one hydroxy group, and the copolymer selection layer may have formed a covalent bond with a polymer separation membrane or a porous polymer support.

The copolymer formed by the copolymerization of the monomer containing an ultraviolet-reactive functional group and the polyethylene glycol-based monomer may be coated on the polymer separation membrane or the porous polymer support composed of a polymer containing an alkyl group, and then ultraviolet rays are irradiated thereon to form a covalent bond between the copolymer and the alkyl group on the surface of the polymer support, thereby forming the selection layer surface-fixed and crosslinked. As described above, the surface fixation and crosslinking of the selection layer may be achieved through the irradiation of ultraviolet rays.

A suitable pressure on a residual side of the separation membrane capable of allowing carbon dioxide and hydrogen to permeate is greatly influenced by the gas selectivity of the separation membrane. A separation membrane having a very high selectivity of carbon dioxide and hydrogen compared to a selectivity of carbon monoxide to be recovered may recover the carbon monoxide to a high purity even at a low pressure. However, if there is no significant selectivity difference, a high pressure is required.

The industrial by-product gas compressed to 5 atm to 20 atm in the compressor of the supply unit is sent to an inlet of the separation membrane capable of allowing carbon dioxide and hydrogen to permeate so that carbon dioxide and hydrogen in the industrial by-product gas permeate the separation membrane and exit therefrom, and carbon monoxide and nitrogen remain on the residual side.

That is, since the first membrane separation unit is to remove carbon dioxide and hydrogen by allowing the same to permeate a permeative side, the separation membrane capable of allowing carbon dioxide and hydrogen to permeate should be a separation membrane having a very high permeability of carbon dioxide and hydrogen compared to a permeability of carbon monoxide, that is, a membrane selectively allowing carbon dioxide and hydrogen to permeate.

However, even if CO₂/CO and H₂/CO selectivities are very high, which are the ratios of the permeability of each of carbon dioxide and hydrogen to that of carbon monoxide, it is more preferable to use two or more connected separation membrane modules than to use one separation membrane module (a bundle of modules in which multiple modules are connected in parallel) in terms of recovering carbon monoxide at a recovery rate of 90% or greater and a purity of 99% or greater.

In an embodiment of the present invention, the first membrane separation unit may have a form in which two separation membrane modules are connected as shown in FIG. 1. That is, a first separation membrane module and a second separation membrane module may be connected in series.

In FIG. 1, the industrial by-product gas is compressed through a compressor and then supplied before being supplied to the first membrane separation unit from the supply unit, and a gas on a permeate side of the second separation membrane module is recirculated to an inlet of the compressor. The concentrated carbon monoxide and nitrogen are discharged through an outlet on a residual side of the second separation membrane module, and carbon dioxide and hydrogen are discharged through an outlet on a permeative side of the first stage separation membrane.

As described above, it is preferable that the residual side of the first separation membrane module and the residual side of the second separation membrane module are operated between 5 atm and 20 atm in consideration of economic feasibility, and the permeative side of the first and the permeative side of the second separation membrane modules may be operated at atmospheric pressure, or if it is a process of a small scale, at a negative pressure using a vacuum pump. If the permeative side is operated at a negative pressure, that is, at a pressure between 0 atm and 1 atm, which is 1 atm or less at an absolute pressure, as it can be predicted from Equation (1) below, which is an equation regarding the permeation flow velocity of a separation membrane, the value P₂y, which is the partial pressure of the permeative side, significantly decreases, and as a result, the value of separation propulsion power (P₁x-P₂y) increases, so the permeation flow velocity V of a gas increases.

V=Q·A(P₁x−P₂y) <Equation 1>

At this time, V denotes a permeation flow rate(Nm³/hr), Q denotes gas permeability(m³/m²·s·Pa), A denotes a membrane area(m²), P₁ denotes residual side pressure(Pa), P₂ denotes permeative side pressure(Pa), x denotes a residual side gas concentration fraction, and y denotes a permeative side gas concentration fraction.

Specifically, as an example, if the residual side is operated at 10 atm and the permeative side is operated at a vacuum pressure of 7.6 torr, that is, 0.01 atm, even when gas concentrations of carbon dioxide on the residual side and on the permeative side are 1% and 99%, respectively, the partial pressure P₁x on the residual side is 10×10³ Pa and the partial pressure P2y on the permeative side is 0.99×10³ Pa, so the driving power is 9.01×10³ Pa. Therefore, even though the concentration on the permeative side is 99%, the carbon dioxide is allowed to continuously permeate the permeative side. If operated not at a negative pressure but at atmospheric pressure, which is 1 atm, P₂y becomes as great as 99×10³ Pa, so that a phenomenon in which the carbon dioxide separated and exited the permeative side flows back to the residual side.

In addition, the carbon monoxide recovery system provided in one aspect of the present invention includes a second membrane separation unit.

The second membrane separation unit may include a polymer membrane in which a transition metal is supported.

The second membrane separation unit may receive a gas remaining in the first membrane separation unit to allow carbon monoxide to permeate.

The gas remaining in the first membrane separation unit may include carbon monoxide and nitrogen, and may include 1% or less of carbon dioxide and hydrogen.

The gas remaining in the first membrane separation unit may be supplied to an inlet on a residual side of the second membrane separation unit.

The gas remaining in the first membrane separation unit is in a high-pressure state since the pressure loss thereof in the first membrane separation unit is small, and thus, may not be separately compressed.

The polymer membrane in which a transition metal is supported may be a facilitated transport separation membrane.

The facilitated transport separation membrane refers to a separation membrane in which an end group of a separation membrane polymer or a compound supported inside a separation membrane and a permeate gate are subjected to a chemical reaction to form a complex, a gas moves toward a permeative side while repeating a reversible reaction, and the gas permeates through a reaction in which gas molecules are separated from the complex by a reverse reaction on the surface of the permeative side. Since only specific components form a complex and permeate, a separation membrane with a high selectivity compared to a typical separation membrane may be prepared.

Although not particularly limited, it is preferable to use one or more selected from the group consisting of Ag, Cu, Ti, Hf, Zr, V, Nb, Ta, Mo, W, Tc, Re, Co, Rh, Ir, Ni, Pd, Pt, Zn and Sn is used as the transition metal. It is more preferable to use Ag or Cu which has a high affinity for carbon monoxide and low raw material costs. Typically, it is preferable that the transition metal is in an ion form, but when in a nanoparticle form, the size thereof may be 0.5 to 50 nm. In addition, it is preferable that the anion of the transition metal is one or more selected from the group consisting of NO₃⁻, BF₄⁻, PF₆⁻, SO₃CF₃⁻, ClO₄⁻, and SbF₆⁻. Typically, NO₃⁻, BF₄⁻, and the like, which are inexpensive, are preferable.

The transition metal may be included in an amount of 5 wt % to 60 wt % based on 100 wt % of a separation membrane to be prepared. When included in an amount of 5 wt % or greater, it is preferable in that the permeability of carbon monoxide and the selectivity of carbon monoxide/nitrogen are improved. When included in an amount of 60 wt % or less, it is preferable in that it is possible to prevent a rapid decrease in selectivity by preventing the occurrence of defects in the membrane due to the precipitation of the transition metal in the separation membrane.

The polymer membrane in which a transition metal is supported may include one or more selected from the group consisting of an acidic polymer and an aminated polymer.

As the acidic polymer, it is preferable to use one or more selected from the group consisting of polyacrylic acid, polymethacrylic acid, alginic acid, and the like, all of which have an acid(—COOH) functional group, or a copolymer thereof. It is more preferable to use polymethacrylic acid or alginic acid, which is inexpensive, and rich in acid functional groups, and thus, may form an ionic bond with the transition metal.

Although not particularly limited, as the aminated polymer, it is preferable to use one or more selected from the group consisting of linear polyethyleneimine (LPEI), branched polyethyleneimine (BPEI), polydopamine, poly(vinylamine), poly(allylamine), poly(l-lysine), chitosan, aminated methylcellulose, aminated ethylcellulose, polyethyleneimine, and the like. It is more preferable to use polyethyleneimine or chitosan, which is inexpensive, and rich in amine groups, and thus, may form a coordination bond with the transition metal.

In addition, both the acidic polymer and the aminated polymer may be included.

When both the acidic polymer and the aminated polymer are included, the acidic polymer and the aminated polymer may be included in a weight ratio of 1:9 to 9:1, in a weight ratio of 2:8 to 8:2, in a weight ratio of 3:7 to 7:3, in a weight ratio of 4:6 to 6:4, or in a weight ratio of 5:5.

When the acidic polymer and the aminated polymer are included in a weight ratio of 1:9 to 9:1, it is preferable in that mechanical properties may be sufficiently improved, and the amount of the transition metal supported may be increased to ensure excellent permeability and selectivity for carbon monoxide.

It is difficult to separate a mixed gas of carbon monoxide and nitrogen with a typical separation membrane since the physical properties of the two materials are similar. However, it is possible to easily separate carbon monoxide and nitrogen by using the above-described polymer membrane in which a transition metal is supported.

Since carbon dioxide and hydrogen are removed in the first membrane separation unit, the gas flow rate is greatly reduced in the transition metal-supported polymer membrane included in the second membrane separation unit, so that a small membrane area and less gas compression power are required. Therefore, even a polymer membrane having a permeability of carbon monoxide of only about 10 GPU may be used.

However, even if the CO/N₂ selectivity of the polymer membrane is very high, it may be more preferable to use two or more connected separation membrane modules than to use one separation membrane module (a bundle of modules in which multiple modules are connected in parallel) in terms of recovering carbon monoxide to a high purity.

In the polymer membrane, the selectivity of carbon monoxide is preferably 10 to 200 as in the case of the separation membrane in the first membrane separation unit. In order to more easily recover carbon monoxide to a high purity, the second membrane separation unit may also be multi-staged.

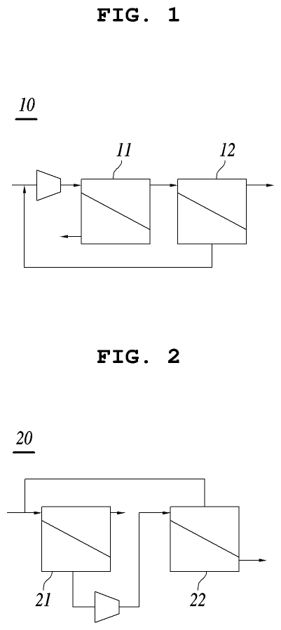

In an embodiment of the present invention, the second membrane separation unit may have a form in which two separation membrane modules are connected as shown in FIG. 2. That is, a third separation membrane module and a fourth separation membrane module may be connected in series.

In a two-stage process of FIG. 2, an outlet gas on a permeative side of the third separation membrane module is compressed with a compressor and then transferred to an inlet on a residual side of the fourth separation membrane module. An outlet gas on the residual side of the fourth separation membrane module is recirculated into an inlet on a residual side of the third separation membrane module, and carbon monoxide is recovered as a final product at an outlet on a permeative side of the fourth separation membrane module, and nitrogen, trace amounts of carbon dioxide and hydrogen are emitted from an outlet of the residual side of the third separation membrane module. The permeative side of the fourth separation membrane module and the permeative side of the third separation membrane module from which carbon monoxide is emitted may be operated at atmospheric pressure, a negative pressure, or a combination of atmospheric pressure and a negative pressure.

It is preferable that the second membrane separation unit is operated between 5 atm and 20 atm as described above in consideration of compression energy costs and carbon monoxide separation efficiency.

Various changes may be made to the carbon monoxide recovery system provided in an aspect of the present invention according to the number of compressors used and the method for connecting separation membranes. Therefore, the rights and scope of the present invention are not limited to the above implementation embodiments.

In addition, the carbon monoxide recovery system provided in an aspect of the present invention may further include a carbon monoxide recovery unit for recovering carbon monoxide which has permeated the second membrane separation unit.

Various changes may be made to the carbon monoxide recovery system provided in an aspect of the present invention according to the connection type of the first membrane separation unit and the second membrane separation unit.

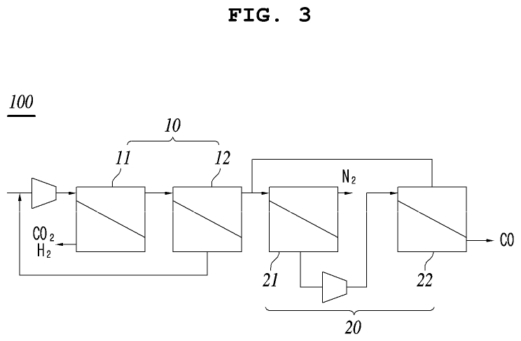

FIG. 3 is a view showing an embodiment of a carbon monoxide recovery system provided in the present invention in which a first membrane separation unit and a second membrane separation unit are connected.

The carbon monoxide recovery system provided in an aspect of the present invention may recover carbon monoxide having a purity of 90% or more at a yield of 90% or more.

Since there are processes in which the number of separation membrane modules and connection type thereof in the first membrane separation unit and the second membrane separation unit vary, a system different from the above system may be implemented according to the selection thereof. An optimal system may be determined by capital expense (CAPEX) and operating expense (OPEX) obtained through an economic feasibility analysis.

In another aspect of the present invention, there is provided a method for recovering carbon monoxide from an industrial by-product, the method including allowing an industrial by-product gas containing carbon dioxide, nitrogen, carbon monoxide, and hydrogen to come into contact with a first membrane separation unit including a separation membrane capable of allowing carbon dioxide and hydrogen to permeate, thereby allowing the carbon dioxide and the hydrogen to permeate, and allowing a gas remaining in the first membrane separation unit to come into contact with a second membrane separation unit including a polymer membrane in which a transition metal is supported, thereby allowing carbon monoxide to permeate.

Hereinafter, each step of a method for recovering carbon monoxide provided in another aspect of the present invention will be described in detail.

Although there is no separate description with respect to the following method for recovering carbon monoxide, all of the contents described with respect to the above-described carbon monoxide recovery system may be applied.

First, the method for recovering carbon monoxide provided in another aspect of the present invention includes a step of allowing an industrial by-product gas to come into contact with a first membrane separation unit, thereby allowing carbon dioxide and hydrogen to permeate.

The industrial by-product gas contains carbon dioxide, nitrogen, carbon monoxide, and hydrogen.

The industrial by-product gas may be a converter gas, a blast furnace gas (BFG), or a COREX furnace gas (CFG) generated in a steel making process of the steel industry.

The converter gas refers to a gas generated during a process of making steel by putting pig iron into a converter and blowing oxygen thereto. Blast furnace gas refers to a gas generated during a stage of making pig iron by putting iron ore and cokes into a blast furnace. Currently, most steel by-product gases including the converter gas and the blast furnace gas are emitted into the atmosphere after being combusted as power generation fuels. However, the carbon monoxide recovery system provided in an aspect of the present invention may recover carbon monoxide from such an industrial by-product gas.

Since the converter gas and the blast furnace gas are gases respectively derived from pig iron and cokes, toxic impurities such as SOₓ are already mostly removed during a step of manufacturing cokes through coal carbonization, and thus, the amount thereof is small. Therefore, it is possible to easily remove the impurities by a typical method.

Although the converter gas and the blast furnace gas contain a trace amount of fine particles, a gas separation membrane which may be used in the first membrane separation unit to be described later does not have a particular problem with the fine particles. A typical polymer gas separation membrane uses a method in which a gas is permeated and separated between molecules inside a thin coating membrane made of a polymer material with no pores, wherein only gas molecules permeate. Therefore, a clogging phenomenon inside the coating membrane due to fine particles does not occur. However, when the fine particles accumulate on the surface of a polymer coating membrane, pressure may increase. However, in this case, when a suitable gas is flown in a direction opposite to the coating membrane, the accumulated fine particles may be easily removed to the outside of the separation membrane.

Before allowing the industrial by-product gas to come into contact with the first membrane separation unit, a step of compressing the industrial by-product gas may be further included. The step of compressing may be performed through a compressor.

A membrane separation process in the first membrane separation unit to be described later is a process of separating a gas using the difference in partial pressure between a residual side and a permeative side, and thus, the compression of a gas to be separated is required. Therefore, a step of compressing the gas through the compressor may be performed.

The pressure of the industrial by-product gas supplied may preferably be an absolute pressure of 5 atm to 20 atm. The higher the pressure, the higher the separation efficiency, so that the better it is when the pressure of a gas to be separated is higher. However, when the pressure of the gas exceeds 20 atm, energy costs are higher compared to other separation techniques such as an absorption method and a pressure circulation adsorption method, which may cause the problem of losing competitiveness. On the contrary, when the pressure of a gas to be separated is less than 5 atm, it is difficult to recover carbon monoxide with a high purity of 99% or greater, and the required area of a separation membrane becomes very large, which may cause the problem of increasing capital expense for securing the separation membrane.

The first membrane separation unit may include a separation membrane capable of allowing carbon dioxide and hydrogen to permeate.

The first membrane separation unit may receive an industrial by-product gas from the supply unit and allow carbon dioxide and hydrogen to permeate, and may allow carbon monoxide and nitrogen to remain.

The first membrane separation unit may be a gas separation membrane made of a polymer material capable of allowing the carbon dioxide and the hydrogen to permeate.

Other contents of the first membrane separation unit are the same as those described above, and thus, will not be repeated.

Next, the method for recovering carbon monoxide provided in another aspect of the present invention includes a step of allowing a gas remaining in the first membrane separation unit to come into contact with a second membrane separation unit, thereby allowing carbon monoxide to permeate.

The second membrane separation unit may include a polymer membrane in which a transition metal is supported.

In the above step, the second membrane separation unit may receive the gas remaining in the first membrane separation unit to allow carbon monoxide to permeate.

In the above step, the gas remaining in the first membrane separation unit may include carbon monoxide and nitrogen, and may include 1% or less of carbon dioxide and hydrogen.

In the above step, the gas remaining in the first membrane separation unit may be supplied to an inlet on a residual side of the second membrane separation unit.

In the above step, the gas remaining in the first membrane separation unit is in a high-pressure state since the pressure loss thereof in the first membrane separation unit is small, and thus, may not be subjected to a separate step of being compressed.

The polymer membrane in which a transition metal is supported may be a facilitated transport separation membrane.

The facilitated transport separation membrane refers to a separation membrane in which an end group of a separation membrane polymer or a compound supported inside a separation membrane and a permeate gate are subjected to a chemical reaction to form a complex, a gas moves toward a permeative side while repeating a reversible reaction, and the gas permeates through a reaction in which gas molecules are separated from the complex by a reverse reaction on the surface of the permeative side. Since only specific components form a complex and permeate, a separation membrane with a high selectivity compared to a typical separation membrane may be prepared.

Other contents of the second membrane separation unit are the same as those described above, and thus, the description thereof will not be repeated.

In another aspect of the present invention, there is provided a system for processing an industrial by-product gas, the system including a supply unit for supplying an industrial by-product gas containing carbon dioxide, nitrogen, carbon monoxide, and hydrogen, a first membrane separation unit including a separation membrane capable of allowing carbon dioxide and hydrogen to permeate, and receiving the industrial by-product gas supplied from the supply unit to allow carbon dioxide and hydrogen to permeate, and a second membrane separation unit including a polymer membrane in which a transition metal is supported, and receiving a gas remaining in the first membrane separation unit to allow carbon monoxide to permeate.

Hereinafter, although there is no separate description with respect to the system for processing an industrial by-product gas provided in another aspect of the present invention, all of the contents described with respect to the above-described carbon monoxide recovery system may be applied.

The system for processing an industrial by-product gas provided in another aspect of the present invention includes a first membrane separation unit and a second membrane separation unit.

The supply unit, the first membrane separation unit, and the second membrane separation unit are the same as described above, and thus, the description thereof will not be repeated.

In addition, the system for processing an industrial by-product gas provided in another aspect of the present invention may further include a cooling unit.

The cooling unit may cool or compress and cool a gas containing carbon dioxide and hydrogen permeated the first membrane separation unit to recover liquefied carbon dioxide.

The gas permeated the first membrane separation unit may include 70% or more of carbon dioxide, up to 80% depending on process conditions.

Since the boiling point of carbon dioxide is −56.6° C., the cooling unit may be set to a pressure of 5 to 50 atm and a temperature of −50° C. to 0° C. Preferably, the cooling unit may be set to a pressure of 10 to 40 atm and a temperature of −40° C. to −10° C., more preferably a pressure of 15 to 25 atm and a temperature of −20° C. to −30° C., and most preferably a pressure of 20 atm and a temperature of −25° C.

A liquid carbon dioxide is sold as a product variously utilized in the industry, so that it is possible to reduce recovery unit costs of carbon monoxide by generating additional income.

That is, the system for processing an industrial by-product gas provided in another aspect of the present invention has an advantage in that carbon monoxide and carbon dioxide may be simultaneously recovered.

In yet another aspect of the present invention, there is provided a method for processing an industrial by-product gas, the method including allowing an industrial by-product gas containing carbon dioxide, nitrogen, carbon monoxide, and hydrogen to come into contact with a first membrane separation unit including a separation membrane capable of allowing carbon dioxide and hydrogen to permeate, thereby allowing the carbon dioxide and the hydrogen to permeate, and allowing a gas remaining in the first membrane separation unit to come into contact with a second membrane separation unit including a polymer membrane in which a transition metal is supported, thereby allowing carbon monoxide to permeate.

Hereinafter, although there is no separate description with respect to the method for processing an industrial by-product gas provided in yet another aspect of the present invention, all of the contents described with respect to the above-described carbon monoxide recovery system may, carbon monoxide recovery method, and industrial by-product gas processing system may be applied.

The step of allowing an industrial by-product gas to come into contact with a first membrane separation unit, thereby allowing carbon dioxide and hydrogen to permeate and the step of allowing a gas remaining in the first membrane separation unit to come into contact with a second membrane separation unit, thereby allowing carbon monoxide to permeate are the same as described above, and thus, the description thereof will not be repeated.

In addition, the method for processing an industrial by-product gas provided in yet another aspect of the present invention may further include a step of compressing and cooling a gas containing the carbon dioxide and the hydrogen permeated the first membrane separation unit to recover liquefied carbon dioxide.

The gas permeated the first membrane separation unit may include 70% or more of carbon dioxide, up to 80% depending on process conditions.

Since the boiling point of carbon dioxide is −56.6° C., in the step, the pressure may be set to 5 to 50 atm and the temperature may be set to −50° C. to 0° C. Preferably, in the step, the pressure may be set to 10 to 40 atm and the temperature may be set to −40° C. to −10° C. More preferably, the pressure may be set to 15 to 25 atm and the temperature may be set to −20° C. to −30° C. Most preferably, the pressure may be set to 20 atm and the temperature may be set to −25° C.

A liquid carbon dioxide is sold as a product variously utilized in the industry, so that it is possible to reduce recovery unit costs of carbon monoxide by generating additional income.

That is, the method for processing an industrial by-product gas provided in yet another aspect of the present invention has an advantage in that carbon monoxide and carbon dioxide may be simultaneously recovered.

Hereinafter, the present invention will be described in detail with reference to embodiments. The scope of the present invention is not limited to specific embodiments, and should be construed by the appended claims. In addition, it should be understood by those skilled in the art that many modifications and variations may be made without departing from the scope of the present invention.

### EXAMPLE 1

A polyamide-block-polyethylene oxide copolymer separation membrane was installed as shown in FIG. 1. The permeabilities of CO, CO₂, N₂, and H₂ in the separation membrane at 0° C. were respectively 4.6 GPU, 350.0 GPU, 3.4 GPU, and 17.5 GPU, and the membrane was disposed on first stage and second stage separation membranes at 0.35 m² and 4.0 m², respectively.

The temperature of a membrane module was dropped to 0° C., and then a converter gas in which the concentrations of CO, CO₂, N₂ and H₂ are respectively 68%, 12%, 18% and 2% was separated at 0° C. in a two-stage process of FIG. 1, and the results are summarized in Table 1.

The recovery rate of CO was 95.53%, and the concentration of CO₂ on a permeative side, on which CO₂ may be recovered as a liquid through compression cooling, was 81.99%.

However, a polyethylene oxide copolymer-based polymer copolymer separation membrane had a low permeability of H₂, so that the concentration of H₂ in a residual gas was 1.785%. However, it causes no problem since H₂ is separated well from CO in a second membrane separation process.

TABLE 1

| | Gas | CO | | | | |
|---|---|---|---|---|---|---|
| | flow rate | recovery | Gas concentration (%) | | | |
| | (Nm³/hr) | rate (%) | CO | N₂ | CO₂ | H₂ |
| Residual | 0.781 | 95.53 | 78.33 | 19.88 | 0.005 | 1.785 |
| side | | | | | | |
| Permeative | 0.219 | — | 13.04 | 2.203 | 81.99 | 2.764 |
| side | | | | | | |

### EXAMPLE 2

A crosslinked polyethylene oxide methacrylate and 4-benzoylphenyl methacrylate copolymer separation membrane was installed as shown in FIG. 1. The permeabilities of CO, CO₂, N₂, and H₂ in the separation membrane at 0° C. were respectively 5.2 GPU, 300.0 GPU, 3.1 GPU, and 20.5 GPU, and the membrane was disposed on first stage and second stage separation membranes at 0.35 m² and 4.0 m², respectively.

Instead of the converter gas, a simulated blast furnace gas in which the concentrations of CO, CO₂, N₂, and H₂ are respectively 25%, 21%, 50% and 4% was prepared, and then supplied at a flow velocity of 1 Nm³/hr in the two-stage membrane separation process shown in FIG. 1 in which the crosslinked polyethylene oxide methacrylate and 4-benzoylphenyl methacrylate copolymer separation membrane was installed at 0.3 m² in the first stage and 4.0 m² in the second stage, thereby separating the blast furnace gas at 0° C. under the same conditions and by the same method as in Example 1.

From the analysis result, it can be seen that CO was recovered at a rate of 96.05% with a total membrane area of 4.3 m², and the concentrations of CO₂ and H₂ in a residual gas were respectively 0.006% and 1.799% (Table 2).

TABLE 2

| | Gas | CO | | | | |
|---|---|---|---|---|---|---|
| | flow rate | recovery | Gas concentration (%) | | | |
| | (Nm³/hr) | rate (%) | CO | N₂ | CO₂ | H₂ |
| Residual | 0.756 | 96.05 | 32.779 | 65.416 | 0.006 | 1.799 |
| side | | | | | | |
| Permeative | 0.244 | — | 4.038 | 5.425 | 85.915 | 4.622 |
| side | | | | | | |

### EXAMPLE 3

When CO₂ and H₂ are removed by supplying the converter gas in a first membrane separation process of Step 1, a gas comes out on a residual side is composed of approximately 80% of CO and 20% of N₂. A mixed gas of Co and N₂ was prepared in the above ratio and compressed, and then supplied at a flow velocity of 0.5 Nm³/h in a two-stage process of FIG. 2, thereby separating CO and N₂ with a chitosan-based facilitated transport membrane (facilitated transport membrane-1).

The facilitated transport membrane used is a composite membrane prepared by coating a thin film of a chitosan polymer on a polysulfone porous support, performing crosslinking with a glutaraldehyde crosslinking agent, and then mixing 3 M of AgNO₃ therewith, the membrane having a CO permeability of 26 GPU and a N₂ permeability of 1.18 GPU at 20° C. When the mixed gas was separated under the membrane area and pressure conditions as shown in Table 3, the CO recovery rate and purity reached 95.61% and 99.3%, respectively.

TABLE 3

| | | | Facilitated |
|---|---|---|---|
| | | | transport |
| | | | membrane-1 |
| Membrane | First stage separation membrane | | 1.5 |
| area (m²) | Membrane area (m²) | | 0.7 |
| | Second stage separation membrane | | |
| | Membrane area (m²) | | 2.2 |
| | Total area | | |
| Pressure | First stage | Residual | 10.0 |
| (Atmospheric | | Pressure | 1.0 |
| pressure) | | (Atmospheric | |
| | | pressure) | |
| | | First stage | |
| | | Transmission | |
| | Pressure | Residual | 10.0 |
| | (Atmospheric | Pressure | 1.0 |
| | pressure) | (Atmospheric | |
| | Second stage | pressure) | |
| | | Second stage | |
| | | Transmission | |

| | | |
|---|---|---|
| Concentration | CO | 99.3 |
| (%) | Concentration (%) | 0.70 |
| | N₂ | |

| | |
|---|---|
| CO recovery rate (%) | 95.61 |

### EXAMPLE 4

As in Example 3, a facilitated transport membrane (facilitated transport membrane-2 having a CO permeability of 36 GPU and a N2 permeability of 1.44 GPU at 20° C.) prepared by coating a thin film of a polyperfluorosulfonic acid polymer on a polysulfone porous support and then mixing 3 M of AgNO3 therewith was used for CO and N₂ separated in the previous stage and remained.

The facilitated transport membrane of Example 4 had no significant difference in CO permeability and selectivity when compared to the facilitated transport membrane of Example 3, and CO of a 99.47% purity was recovered at a 96.52% yield (Table 4).

TABLE 4

| | | | Facilitated |
|---|---|---|---|
| | | | transport |
| | | | membrane-2 |
| Membrane | First stage separation membrane | | 1.2 |
| area (m²) | Membrane area (m²) | | 0.5 |
| | Second stage separation membrane | | |
| | Membrane area (m²) | | 1.7 |
| | Total area | | |
| Pressure | First stage | Residual | 10.0 |
| (Atmospheric | | Pressure | 1.0 |
| pressure) | | (Atmospheric | |
| | | pressure) | |
| | | First stage | |
| | | Transmission | |
| | Pressure | Residual | 10.0 |
| | (Atmospheric | Pressure | 1.0 |
| | pressure) | (Atmospheric | |
| | Second stage | pressure) | |
| | | Second stage | |
| | | Transmission | |

| | | |
|---|---|---|
| Concentration | CO | 99.47 |
| (%) | Concentration (%) | 0.53 |
| | N₂ | |

| | |
|---|---|
| CO recovery rate (%) | 96.52 |

### EXAMPLE 5

A converter gas was compressed to the pressure shown in Table 5, and then supplied at a flow velocity of 1.0 Nm³/hr in an integrated membrane separation process of FIG. 3 and separated to recover CO and liquefied CO₂.

The integrated process of FIG. 3 is a process in which the two-stage process of FIG. 1 (the first membrane separation process) and the two-stage process of FIG. 2 (the second membrane separation process) are combined. In the first membrane separation process, the polyimide-block-polyethylene oxide copolymer composite used in Example 1 was assigned and installed, and in the second membrane separation process, the facilitated transport composite membrane-1 made of a chitosan material crosslinked with a glutaraldehyde crosslinking agent was assigned and installed.

When the converter gas was separated with the membrane area of Table 5, CO of a 99.02% purity was recovered at a 93.08% yield. A gas discharged from the permeation side of the first stage separation membrane of the first membrane separation process had a flow rate of 0.219 Nm³/hr, and was composed of 13.04% of CO, 81.99% of CO₂, 2.76% of N₂, and 2.20% of H₂. When the gas containing 81.99% CO₂ was compressed to 20 atm and then cooled to −25° C., 0.29 kg of liquid CO₂ was obtained per hour.

TABLE 5

| | | | Converter |
|---|---|---|---|
| | | | gas |
| Membrane area | First process | First stage | 0.35 |
| (m²) | | separation | |
| | | membrane | |
| | | Second stage | 4.0 |
| | | separation | |
| | | membrane | |
| | Second process | First stage | 2.0 |
| | | separation | |
| | | membrane | |
| | | Second stage | 0.85 |
| | | separation | |
| | | membrane | |
| Pressure | First process | Residual side | 10.0 |
| (Atmospheric | | Permeative side | 1.0 |
| pressure) | Second process | Residual side | 10.0 |
| | | Permeative side | 1.0 |

| | | |
|---|---|---|
| Concentration | CO | 99.021 |
| (%) | N₂ | 0.907 |
| | CO₂ | 0.003 |
| | H₂ | 0.07 |

| | |
|---|---|
| CO recovery rate (%) | 93.08 |

### EXAMPLE 6

The process was performed in the same manner as in Example 5 except that the converter gas was replaced by a blast furnace gas, and the blast furnace gas was compressed to the pressure given under the membrane area of Table 6, and supplied at a flow velocity of 1.0 Nm³/hr in the integrated membrane separation process of FIG. 3 and separated to recover CO and liquefied CO₂.

In addition, in the first membrane separation process, the crosslinked polyethylene oxide methacrylate and 4-benzoylphenyl methacrylate copolymer composite membrane used in Example 2 was assigned and installed, and in the second membrane separation process, the facilitated transport composite membrane-2 made of a polyperfluorosulfonic acid polymer used in Example 4 was assigned and installed.

The pressure and membrane area (Table 6) were suitably adjusted, and then the blast furnace gas was separated in the integrated membrane separation process of FIG. 3 under the separation conditions and method of Example 6. As a result, CO of a 99.08% purity was recovered at a 90.29% yield of from the blast furnace gas having a CO concentration of 25%.

TABLE 6

| | | | Blast |
|---|---|---|---|
| | | | furnace |
| | | | gas |
| Membrane area | First process | First stage | 0.3 |
| (m²) | | separation | |
| | | membrane | |
| | | Second stage | 4.0 |
| | | separation | |
| | | membrane | |
| | Second process | First stage | 5.5 |
| | | separation | |
| | | membrane | |
| | | Second stage | 0.26 |
| | | separation | |
| | | membrane | |
| Pressure | First process | Residual side | 12.0 |
| (Atmospheric | | Permeative side | 1.0 |
| pressure) | Second process | Residual side | 12.0 |
| | | Permeative side | 1.0 |

| Concentration | CO | 99.085 | |
|---|---|---|---|
| (%) | N₂ | 0.877 | |
| | CO₂ | 0.000 | |
| | H₂ | .07 | 0.038 |

| | | |
|---|---|---|
| CO recovery rate (%) | 3.08 | 90.29 |

A carbon monoxide recovery system according to an aspect of the present invention has advantages in that separation costs are low since it is possible to recover carbon monoxide to a high purity from an industrial by-product gas only by operating pressure at room temperature without having to use separate raw materials, auxiliary raw materials, and thermal energy, capital expense are also low since the process the system is simple, and economic feasibility is high since it is possible to obtain liquefied CO₂ as well, which may generate additional income.

In addition, by recovering high-purity carbon monoxide of a chemical raw material-grade from an industrial by-product gas, it is possible to reduce the amount of fossil fuels used to produce carbon monoxide, and since carbon dioxide to be emitted into the atmosphere is recovered as liquefied carbon dioxide, there is a dual effect of reducing greenhouse gas emissions.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### DESCRIPTION OF THE REFERENCE NUMERALS OR SYMBOLS

10 First membrane separation unit

11 First separation membrane module

12 Second separation membrane module

20 Second membrane separation unit

21 Third separation membrane module

22 Fourth separation membrane module

100 Carbon monoxide recovery system

What is claimed is:

1. A system for recovering carbon monoxide from an industrial by-product gas, the system comprising:
a supply unit for supplying an industrial by-product gas containing carbon dioxide, nitrogen, carbon monoxide, and hydrogen;
a first membrane separation unit including a separation membrane capable of allowing carbon dioxide and hydrogen to permeate, and receiving the industrial by-product gas supplied from the supply unit to allow carbon dioxide and hydrogen to permeate; and
a second membrane separation unit including a polymer membrane in which a transition metal is supported, and receiving a gas remaining in the first membrane separation unit to allow carbon monoxide to permeate.

2. The system of claim 1, wherein the supply unit further comprises a compressor for compressing the industrial by-product gas.

3. The system of claim 1, further comprising a carbon monoxide recovery unit for recovering the carbon monoxide which has permeated the second membrane separation unit.

4. The system of claim 1, wherein the separation membrane capable of allowing carbon dioxide and hydrogen to permeate is a polyolefin oxide-based polymer membrane.

5. The system of claim 1, wherein the separation membrane capable of allowing carbon dioxide and hydrogen to permeate has a carbon dioxide/carbon monoxide selectivity and a hydrogen/carbon monoxide selectivity of 10 to 200, and a permeability of carbon dioxide and hydrogen of 20 GPU or greater.

6. The system of claim 1, wherein the transition metal is one or more selected from the group consisting of Ag, Cu, Ti, Hf, Zr, V, Nb, Ta, Mo, W, Tc, Re, Co, Rh, Jr, Ni, Pd, Pt, Zn, and Sn.

7. The system of claim 1, wherein the polymer membrane in which a transition metal is supported comprises one or more selected from the group consisting of an acidic polymer and an aminated polymer.

8. A method for recovering carbon monoxide from an industrial by-product gas, the method comprising:
allowing an industrial by-product gas containing carbon dioxide, nitrogen, carbon monoxide, and hydrogen to come into contact with a first membrane separation unit including a separation membrane capable of allowing carbon dioxide and hydrogen to permeate, thereby allowing the carbon dioxide and the hydrogen to permeate; and
allowing a gas remaining in the first membrane separation unit to come into contact with a second membrane separation unit including a polymer membrane in which a transition metal is supported, thereby allowing carbon monoxide to permeate.

9. A system for processing an industrial by-product gas, the system comprising:
a supply unit for supplying an industrial by-product gas containing carbon dioxide, nitrogen, carbon monoxide, and hydrogen;
a first membrane separation unit including a separation membrane capable of allowing carbon dioxide and hydrogen to permeate, and receiving the industrial by-product gas supplied from the supply unit to allow carbon dioxide and hydrogen to permeate; and
a second membrane separation unit including a polymer membrane in which a transition metal is supported, and receiving a gas remaining in the first membrane separation unit to allow carbon monoxide to permeate.

10. The system of claim 9, further comprising a cooling unit for cooling a gas containing the carbon dioxide and the hydrogen which have permeated the first membrane separation unit to recover liquefied carbon dioxide.
